(19) United States
(12) Patent Application Publication
(10) Pub. No.: US 2004/0200724 A1
(43) Pub. Date: Oct. 14, 2004

(54) Microfluidic device

(76) Inventors: Teruo Fujii, Meguro-ku (JP); Yasuhiro Sando, Amagasaki-shi (JP); Yasuhisa Fujii, Kyoto-shi (JP); Kusunoki Higashino, Osaka-shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/664,436

(22) Filed: Sep. 17, 2003

(30) Foreign Application Priority Data
Sep. 19, 2002 (JP) 2002-273237

(51) Int. Cl. B32B 5/02; C25B 9/00

(52) U.S. Cl. 204/601; 422/100

(57) ABSTRACT

A microfluidic device is provided in which dead volume is small, response is satisfactory and a channel can be changed easily depending on application of an analysis or a synthesis. The microfluidic device includes pump units each of which has a first joint surface, a pumping mechanism and channels that connect to the pumping mechanism and opens to the first joint surface, and a channel unit having a second joint surface for being detachably joined to the first joint surface and channels that open to the second joint surface and are connectable to the channels of the pump unit. At least one of a material constituting the first joint surface and a material constituting the second joint surface is an elastic material having a self-sealing feature.

This application is based on Japanese Patent Application No. 2002-273237 filed on Sep. 19, 2002, the contents of which are hereby incorporated by reference.

### BACKGROUND OF THE INVENTION

1. Field of the Invention

The present invention relates to a microfluidic device used for a chemical analysis, a chemical synthesis or others.

2. Description of the Related Art

In recent years, a μ-TAS (Micro Total Analysis System) has drawn attention that uses a micromachining technique to microfabricate equipment for a chemical analysis or a chemical synthesis and then to perform the chemical analysis or the chemical synthesis in a microscale method. Compared to the conventional systems, a miniaturized μ-TAS has advantages in that required sample volume is small, reaction time is short, the amount of waste is small and others. The use of the μ-TAS in the medical field lessens the burden of patients by reducing volume of specimen such as blood, and lowers the cost of examination by reducing reagent volume. Further, the reduction of the specimen and reagent volume causes reaction time to shorten substantially, ensuring that examination efficiency is enhanced. Moreover, since the μ-TAS is superior in portability, it is expected to apply to broad fields including the medical field and an environmental analysis.

In a chemical analysis, environmental measurement or others using a microfluidic system, liquid transport means such as a micropump or a syringe pump is required in order to perform liquid transport, mixing and detection on a device (a chip). In a case where the liquid transport means is structurally separated from the chip, some kind of interface is needed to connect therebetween. However, a problem arises in which air bubbles are mixed upon the connection. Additionally, since dead volume at the connection portion is large, the response is degraded to make precise control of liquid transport difficult, or an excess specimen or reagent is required. In a case where external liquid transport means such as a syringe pump is connected to the chip, the whole device is voluminous, which makes it impossible to take advantage of the microfluidic system.

Concerning a micropump using silicon micromachining, a variety of reports are provided, for example, Japanese unexamined patent publication No. 10-299659, Japanese unexamined patent publication No. 10-110681 and Japanese unexamined patent publication No. 2001-322099.

Conventionally, there are proposed structures of a single micropump, microfluidic devices in each of which a micropump is integral with a channel substrate and others, as mentioned above.

However, in the case of conducting various analyses or syntheses using the microfluidic devices proposed conventionally, it is necessary to structure a microfluidic device individually in accordance with the contents of the analyses or the syntheses. More specifically, when various analyses or syntheses are intended, changes of channels in response to the contents thereof are far from easy.

Related Patent Publication 1:

Japanese unexamined patent publication No. 10-299659

Related Patent Publication 2:

Japanese unexamined patent publication No. 10-110681

Related Patent Publication 3:

Japanese unexamined patent publication No. 2001-322099

### SUMMARY OF THE INVENTION

It is an object of the present invention to provide a microfluidic device in which dead volume is small, response is satisfactory and a channel can be changed easily depending on application of an analysis or a synthesis.

According to one aspect of the present invention, a microfluidic device includes a pump unit including a first joint surface, a pumping mechanism and a channel that connects to the pumping mechanism and opens to the first joint surface; and a channel unit including a second joint surface for being detachably joined to the first joint surface and a channel that opens to the second joint surface and is connectable to the channel of the pump unit, wherein at least one of a material constituting the first joint surface and a material constituting the second joint surface is an elastic material having a self-sealing feature.

According to another aspect of the present invention, a microfluidic device includes a pump unit including a first joint surface, a pumping mechanism and a first channel that connects to the pumping mechanism and opens to the first joint surface; a channel unit including a second joint surface and a second channel opening to the second joint surface; and a sheet-like member including a third joint surface to be bonded to the first joint surface, a fourth joint surface to be bonded to the second joint surface and a connection hole for connecting the first channel and the second channel, wherein the sheet-like member is made from an elastic material having a self-sealing feature and is detachably joined to at least one of the channel unit and the pump unit.

Preferably, the sheet-like member is structured by a PDMS. Further, the sheet-like member has translucency. At least one of the pump unit and the channel unit should be a sheet-like shape.

In the present invention, a self-sealing feature means a property of cohering to a surface to be contacted to a degree in which no liquid leaks without applying external force and of maintaining the coherence. Additionally, elastic materials include materials having elasticity enough to cause elastic deformation by human's bare-handed strength.

These and other characteristics and objects of the present invention will become more apparent by the following descriptions of preferred embodiments with reference to drawings.

### BRIEF DESCRIPTION OF THE DRAWINGS

FIG. 1 is an exploded perspective view of a microfluidic device according to a first embodiment of the present invention.

FIG. 2 is a front sectional view of the microfluidic device.

FIG. 3 is a plan view of a micropump chip.

FIG. 4 is a plan view of a channel chip.

FIG. 5 is an explanatory diagram of a part of a fabrication process of the channel chip.

FIGS. 6A and 6B show examples of waveforms of drive voltage of a piezoelectric element.

FIGS. 7A-7D show states of a liquid in the vicinity of a confluence of a channel.

FIG. 8 is a perspective view of a modified microfluidic device.

FIG. 9 is a perspective view of another modified microfluidic device.

FIG. 10 is a perspective view of still another modified microfluidic device.

FIG. 11 is a perspective view of a further modified microfluidic device.

FIG. 12 is a front sectional view of a microfluidic device according to a second embodiment.

FIG. 13 is a perspective view of a modified microfluidic device.

FIG. 14 is a front sectional view of another modified microfluidic device.

FIG. 15 is a perspective view of the microfluidic device shown in FIG. 14.

FIG. 16 is a front sectional view of still another modified microfluidic device.

FIG. 17 is a perspective view of a further modified microfluidic device.

FIG. 18 is a perspective view of other modified microfluidic device.

### DESCRIPTION OF THE PREFERRED EMBODIMENTS

[First Embodiment]

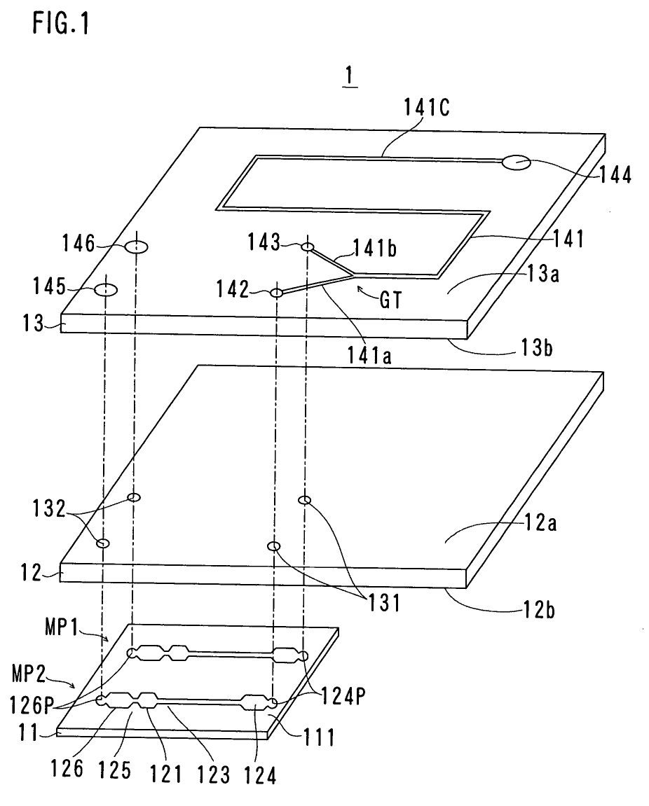

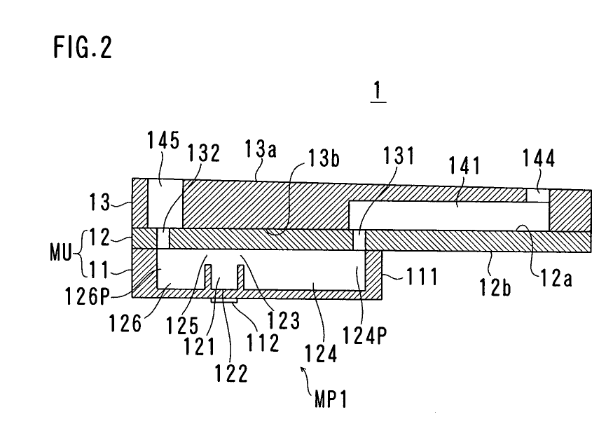

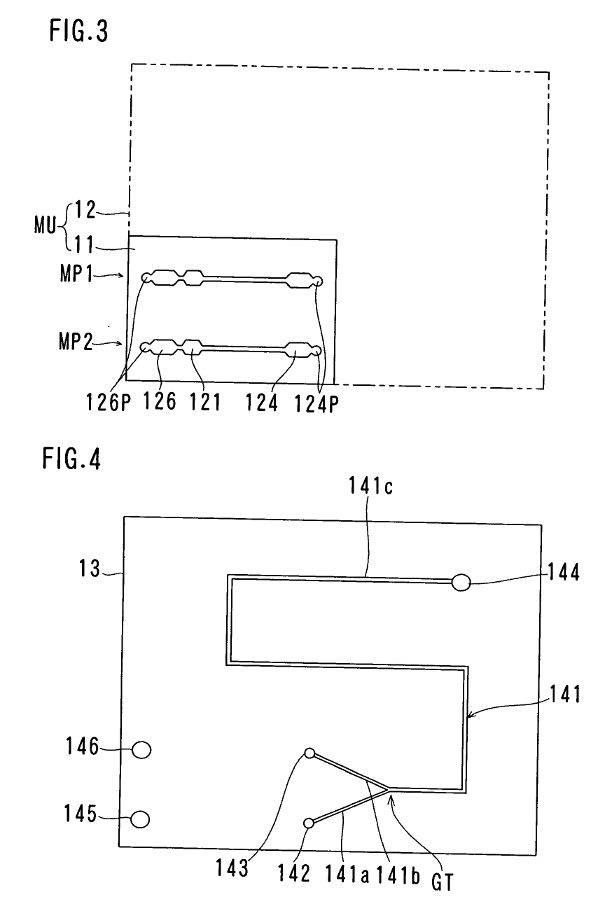

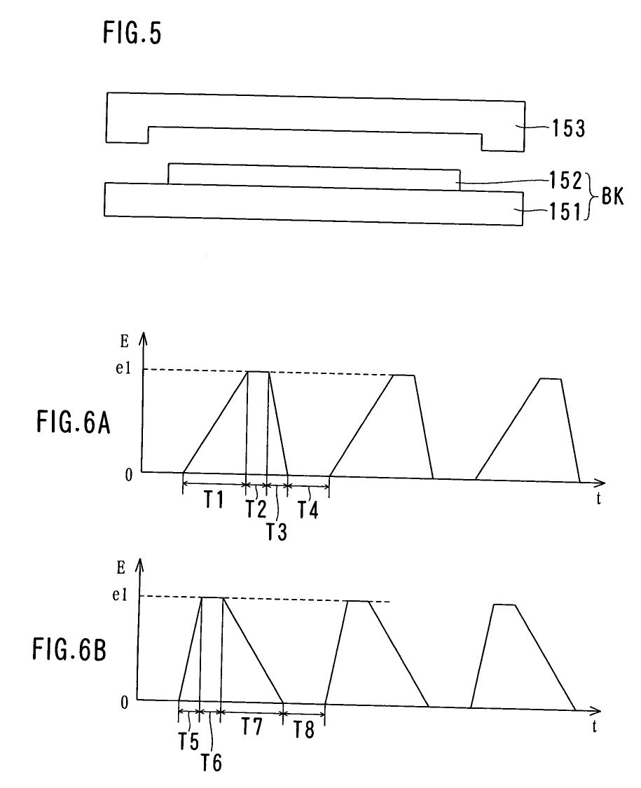

FIG. 1 is an exploded perspective view of a microfluidic device 1 according to a first embodiment of the present invention, FIG. 2 is a front sectional view of the microfluidic device 1, FIG. 3 is a plan view of a micropump chip 11, FIG. 4 is a plan view of a channel chip 13, FIG. 5 is an explanatory diagram of a part of a fabrication process of the channel chip 13 and FIGS. 6A and 6B show examples of waveforms of drive voltage of a piezoelectric element 112.

Referring to FIG. 1, a channel 141 and hollows 142 and 143 formed at the channel chip 13 are illustrated as if being exposed to an upper surface of the drawing. However, the transparency of the channel chip 13 causes them to appear to be exposed. In fact, the channel 141 and the hollows 142 and 143 are formed on a lower surface of the channel chip 13 as described below.

As shown in FIGS. 1 and 2, the microfluidic device 1 includes the micropump chip 11, a glass substrate 12 and the channel chip 13.

The micropump chip 11 has a silicon substrate 111, a piezoelectric element (PZT) 112 and flexible wiring (not shown). In the illustrated example, two diffuser micropumps MP1 and MP2 are formed on the micropump chip 11. Since the micropumps MP1 and MP2 have the same structure, explanation is made to the structure of one of the micropumps below in the application.

The silicon substrate 111 is a rectangular sheet whose dimensions are 17×35×0.2 mm, for example. The silicon substrate 111 is formed by patterning a silicon wafer to a predetermined shape using a known photolithography process. More specifically, an ICP dry etching system is used to etch the patterned silicon substrate to a predetermined depth, for example. Each of the micropumps MP1 and MP2 formed on the silicon substrate 111 has a pump chamber 121, a diaphragm 122, a first throttle channel 123, a first channel 124, a second throttle channel 125 and a second channel 126. The end of each of the first channels 124 is provided with a port 124P, while the end of each of the second channels 126 is provided with a port 126P.

The first throttle channel 123 has low channel resistance when the differential pressure between the inlet side and the outlet side thereof is close to zero. As the differential pressure in the first throttle channel 123 increases, the channel resistance thereof increase. Stated differently, pressure dependence is large. Compared to the case of the first throttle channel 123, the second throttle channel 125 has higher channel resistance when the differential pressure is close to zero. However, the second throttle channel 125 has little pressure dependence. Even if the differential pressure in the second throttle channel 125 increases, the channel resistance thereof does not change significantly. When the differential pressure is large, the second throttle channel 125 has channel resistance lower than the first throttle channel 123 has.

The characteristics of channel resistance mentioned above can be obtained by any of the following: 1. Bringing a liquid (a fluid) flowing through a channel to be turbulent flow depending on the magnitude of the differential pressure. 2. Bringing the liquid (the fluid) to be laminar flow constantly regardless of the differential pressure. More particularly, for example, the first throttle channel 123 is provided in the form of an orifice having a short channel length and the second throttle channel 125 is provided in the form of a nozzle that has the same internal diameter as the first throttle channel 123 and has a long channel length. In this way, the characteristics of channel resistance discussed above can be realized.

The channel resistance characteristics of the first throttle channel 123 and the second throttle channel 125 are used to produce pressure in the pump chamber 121 and the change ratio of the pressure is controlled, so that a pumping action, such as discharging a liquid to a throttle channel in which channel resistance is lower can be realized.

More specifically, the pressure in the pump chamber 121 is raised and the change ratio of the pressure is made small, resulting in preventing the differential pressure from increasing substantially. Accordingly, the channel resistance of the first throttle channel 123 is maintained lower than that of the second throttle channel 125, so that a liquid within the pump chamber 121 is discharged from the first throttle channel 123 (a discharge process). The pressure in the pump chamber 121 is lowered and the change ratio of the pressure is made large, resulting in the increased differential pressure. Accordingly, the channel resistance of the first throttle channel 123 is higher than that of the second throttle channel 125, so that a liquid flows from the second throttle channel 125 into the pump chamber 121 (a suction process).

To the contrary, the pressure in the pump chamber 121 is raised and the change ratio of the pressure is made large, resulting in the high differential pressure. Accordingly, the channel resistance of the first throttle channel 123 is higher than that of the second throttle channel 125, so that a liquid within the pump chamber 121 is discharged from the second throttle channel 125 (a discharge process). The pressure in the pump chamber 121 is lowered and the change ratio of the pressure is made small, resulting in the low differential pressure. Accordingly, the channel resistance of the first throttle channel 123 is lower than that of the second throttle channel 125, so that a liquid flows from the first throttle channel 123 into the pump chamber 121 (a suction process).

The drive voltage supplied to the piezoelectric element 112 is controlled and the amount and timing of deformation of the diaphragm 122 are controlled, which realizes pressure control of the pump chamber 121 mentioned above. For example, drive voltage having a waveform shown in FIG. 6A is applied to the piezoelectric element 112, leading to discharge from the port 124P. Drive voltage having a waveform shown in FIG. 6B is applied to the piezoelectric element 112, leading to discharge from the port 126P.

Referring to FIGS. 6A and 6B, maximum voltage e1 to be applied ranges approximately from several volts to several tens of volts and is about 100 volts at the maximum. Time T1 and T7 are on the order of 60 μs, time T2 and T6 are approximately several microseconds and time T3 and T5 are about 20 μs. Frequency of the drive voltage is approximately 11 KHz.

As illustrated clearly in FIG. 3, the first channel 124 and the second channel 126 are provided with elongated octagon reservoirs at portions connected to the ports 124P and 126P, respectively, each of the reservoirs having approximate dimensions of width 1 mm, length 4 mm and depth 0.2 mm. Each of the reservoirs functions as a damper for absorbing reflection components of a liquid and is intended to improve the performance of the micropump MP1 or MP2.

The contact surface with a liquid in each of the micropumps MP1 and MP2 is subjected to thermal oxidation and hydrophilic treatment. Since the micropumps MP1 and MP2 are fabricated together in the photolithography process, variations in dimensions and others are small and errors of liquid transport characteristics hardly occur.

The piezoelectric element 112 mentioned above is attached to the outer surface of the diaphragm 122. Two electrodes for driving the piezoelectric element 112 are pulled out to the both surfaces of the piezoelectric element 112 to connect with the flexible wiring (not shown). More specifically, in order to connect with the flexible wiring, an ITO film that is a transparent electrode film is formed on the surface of the diaphragm 122 and an adhesive is used to adhere the one surface of the piezoelectric element 112 onto the ITO film. Thereby, one electrode of the piezoelectric element 112 is electrically connected to the ITO film, and the ITO film is connected to the flexible wiring. The other surface of the piezoelectric element 112 is gilded and the flexible wiring is directly connected to the gilded part. The flexible wiring per se is adhered to the silicon substrate 111 with an adhesive, which prevents excessive force on the portions connected to the electrodes.

The glass substrate 12 is a rectangular plate with dimensions of 50×76×1 mm, for example. The glass substrate 12 has smooth surfaces 12a and 12b and is entirely transparent. As the glass substrate 12, for instance, Pyrex glass (Pyrex is a registered trademark of Corning Glass Works), Tempax glass (Tempax is a registered trademark of Schott Glaswerk) or the like can be used. These glasses have the same coefficient of thermal expansion as materials of the micropump chip 11 have. The glass substrate 12 has through-holes 131 and 132 at positions corresponding to the ports 124P and 126P, respectively, each of the through-holes having a diameter of approximately 1.2 mm. Since two micropumps are provided, two sets of the through-holes are provided actually.

The micropump chip 11 discussed above is bonded to the rear surface (the surface 12b) of the glass substrate 12 by means of anodic bonding so that two sides of the micropump chip 11 correspond to two sides of the glass substrate 12.

The integrated structure of the micropump chip 11 and the glass substrate 12 constitutes a micropump unit MU. The above-mentioned operation of the micropumps MP1 and MP2 causes the micropump unit MU to suck a liquid from the through-holes 132 and to discharge the same from the through-holes 131. Control of the drive voltage to be applied to the piezoelectric element 112 allows to reverse two directions of the liquid suction and the liquid discharge. With respect to the structure of the micropump chip 11 itself, it is possible to make reference to Japanese unexamined patent publication No. 2001-322099 that is set forth in Description of the Related Art.

The channel chip 13 is a rectangular plate with dimensions of 50×76×3 mm, for example. The channel chip 13 is made from an elastic material having a self-sealing feature, is transparent or translucent and has translucency. The self-sealing feature of the channel chip 13 permits the channel chip 13 to adsorb spontaneously without applying external force or using an adhesive merely by placing the channel chip 13 on the surface 12a of the glass substrate 12, so that the lower surface 13b coheres to the surface 12a of the glass substrate 12. Then, a sealing feature is brought out between the lower surface 13b and the surface 12a and is maintained, and therefore no liquid therebetween leak outside. As a material having such a feature, for example, a PDMS (Polydimethylsiloxane) that is one kind of a silicone rubber is used. Examples of commercial items of the PDMS include, for instance, Dow Corning “Sylgard 184”.

On the channel chip 13 is patterned the channel 141 for a chemical analysis or a chemical synthesis on the surface 13b side. In the illustrated example, the channel 141 includes channels 141a, 141b and 141c, the two channels 141a and 141b interflowing to the channel 141c. As one example of dimensions and a shape, the channel 141 is a groove whose cross-section is rectangle with a width of approximately 100 μm and a depth of around 100 μm. The channel 141c has a cross-sectional area larger than that of each of the channels 141a and 141b.

The channel chip 13 has hollows 142 and 143 at the starting ends of the channels 141a and 141b, respectively, the hollows 142 and 143 corresponding to the two through-holes 131 on the glass substrate 12 and not penetrating through the surface 13a. Further, the channel chip 13 has a hole 144 at the terminating end of the channel 141c, the hole penetrating through the surface 13a. The hole 144 serves to discharge a liquid that passes through the channel 141 to be no more needed, and has a diameter larger than other holes and hollows have. Moreover, the channel chip 13 is provided with holes 145 and 146 each of which has an internal diameter of approximately 4 mm at the positions corresponding to the two through-holes 132 on the glass substrate 12. On the occasion of use of the microfluidic device 1, each of the holes 145 and 146 works as a reservoir for liquids for analyses. The holes 144, 145 and 146 can be formed easily with a punch or a drill.

Since the channel chip 13 has the self-sealing feature as described above, the channel chip 13 clings to the surface 12a of the glass substrate 12 to be sealed merely by placing the same on the surface 12a, so that the microfluidic device 1 can be structured simply and easily. Additionally, the channel chip 13 is detached from the glass substrate 12 to be separated therefrom readily, ensuring that the channel chip 13 can be washed or replaced with another channel chip 13 having another channel structure easily. Further, the channel chip 13 is thin such as a thickness of approximately a few millimeters, and portability and workability thereof are good. There is another advantage of space-saving when the microfluidic device 1 using the channel chip 13 is mounted onto various devices for detection or others.

Such a channel chip 13 can be fabricated as follows. As shown in FIG. 5, a silicon substrate 151 is spin-coated with a thick film resist 152. Then, a photolithography process is used to create a matrix BK in which the portion of the channel 141 is convex. The PDMS is poured into the matrix BK to be heated and hardened. The hardened chip 153 is detached from the matrix BK, so that the channel chip 13 is completed. The matrix BK can be used repeatedly, leading to mass production of the channel chip 13 easily and inexpensively. As a material of the thick film resist 152, MicroChem SU-8 can be used, for example.

The microfluidic device 1 structured above operates as follows.

Two kinds of liquids for an analysis or a synthesis are supplied from the holes 145 and 146. The liquids are introduced from the holes 145 and 146 into the ports 126P via the through-holes 132, respectively. The micropumps MP1 and MP2 discharge the liquids from the ports 124P to flow into the hollows 143 and 142 via the through-holes 131, respectively. Then, the liquids from the hollows 142 and 143 pass through the channels 141a and 141b respectively to flow together at a confluence GT. After that, the liquids pass through the channel 141c to provide laminar flow. During flowing through the channel 141c, the two kinds of liquids diffuse spontaneously to mix with each other gradually, so that expected chemical reactions occur. In accordance with the reactions, a variety of detections are performed at the downstream of the channel 141, the detections including detection of light emission, fluorescent detection, colorimetry, nephelometry and detection of scattered light. The liquids end up being discharged from the hole 144.

When liquids are delivered from the ports 124P as mentioned above, drive voltage shown in FIG. 6A is applied to the piezoelectric element 112. When the liquids delivered from the ports 124P are intended to flow backward, drive voltage shown in FIG. 6B is applied to the piezoelectric element 112. The process for reversing the flow of the liquid is effective, for example, when only one kind of liquid is used and reversible changes are observed many times.

The microfluidic device 1 as structured above is extremely small and is superior in portability and workability. The micropump chip 11 is integral with the glass substrate 12 and the channel chip 13 adheres to the surface 12a of the glass substrate 12 directly, which eliminates the possibility of causing a problem that air bubbles are mixed into a liquid. The micropump unit MU is compatible with the channel chip 13 in terms of connection and, one analysis unit or one experimental unit can be structured without connection components. Additionally, since dead volume between the micropump MP and the channel 141 on the channel chip 13 is extremely small, the operation of the micropump MP is directly reflected in the liquid movement in the channel 141 to achieve good response, and precise control of liquid transport is easy. It is possible to control accurately, for example, timing when a liquid is delivered to the channel 141, liquid volume, a change ratio of the liquid volume and the delivery direction with ease. No futile specimen and reagent are required.

The channel chip 13 can be replaced with another channel chip readily depending on contents of an analysis or a synthesis. Accordingly, the channel structure can be changed with ease. Further, the used channel chip 13 can be removed easily and be washed by ethanol or others for reuse, and a series of the processes is simple. A liquid used for the microfluidic device 1 is not necessarily a water-soluble liquid and all types of liquids can be used for the microfluidic device 1.

The drive of the micropump chip 11 needs application of low voltage with several tens of volts. Thus, it is easy to drive, control and handle the micropump chip 11 compared to, for example, an electrophoresis chip that is conventionally used and requires voltage of several kilovolts.

The PDMS used as a material for the channel chip 13 has superior light transmittance and is suitable for observation of a liquid flowing through the channel 141 and detection of light transmitted or reflected by a liquid. However, the material for the channel chip 13 is not necessarily PDMS. Any elastic materials (soft elastic materials) are possible if capable of self-sealing, such as a silicone rubber.

In the present embodiment, the channel chip 13 is made to have the self-sealing feature. However, in lieu of the channel chip 13, the self-sealing feature may be given to the surface 12a of the glass substrate 12 constituting the micropump unit MU. In each case, in order to give the self-sealing feature, a surface of a member formed by a material without the self-sealing feature may be coated with a member having the self-sealing feature, instead of forming a member by a material with the self-sealing feature. As a coating technique in this case, various known methods can be used.

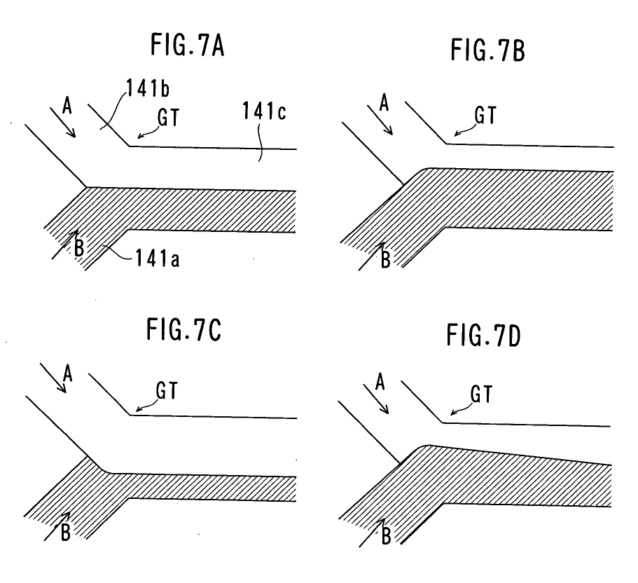

FIGS. 7A-7D show states of a liquid in the vicinity of the confluence GT of the channel 141.

The piezoelectric elements 112 of the micropumps MP1 and MP2 can be controlled independently of each other. For example, drive voltage, waveforms, frequency and others are changed individually for each of the piezoelectric elements 112, which allows for control of liquid transport balance of two kinds of liquids A and B that are delivered by the micropumps MP1 and MP2.

FIGS. 7A, 7B and 7C show cases in which a liquid transport ratio of A to B is 1:1, 1:4 and 4:1, respectively. The liquid transport ratios can be realized by setting a ratio of A to B that is a ratio of magnitude of drive voltage to be applied to the piezoelectric elements 112 to 1:1, 1:2 and 2:1, respectively. Actual voltage is set to, for example, 10 volts:10 volts, 10 volts:20 volts and 20 volts:10 volts. The discharge amount from the micropumps MP1 and MP2 is usually proportional to magnitude of drive voltage. However, force of a liquid flowing into the confluence GT from each of the channels 141a and 141b influence the actual flow rate, and therefore, there are many cases in which a proportion of the discharge amount have no correspondence with the liquid transport ratio.

The liquid transport ratios of A to B can be changed while each of the micropumps MP1 and MP2 transports a liquid. As shown in FIG. 7D, for example, the liquid transport ratio of A to B is changed linearly, so that a concentration gradient and a pH gradient can be formed in the mixture of the two kinds of liquids A and B.

In any event, control of drive voltage allows for adjustment of the amount of the two kinds of liquids A and B, then to obtain desired reactions in the channel 141.

Various selections of the crossing angle of the channels 141a and 141b at the confluence GT enables the liquid transport ratio to be adjusted.

[Modified Example in the First Embodiment]

Next, a modified example of the microfluidic device in the embodiment discussed above is described.

In the microfluidic device 1 mentioned above, the micropump chip 11 is provided with the two micropumps MP1 and MP2. However, the micropump chip 11 may be provided with one micropump MP or three or more micropumps MP. Further, the micropumps MP may differ from each other in specification such as discharge amount, discharge pressure or others.

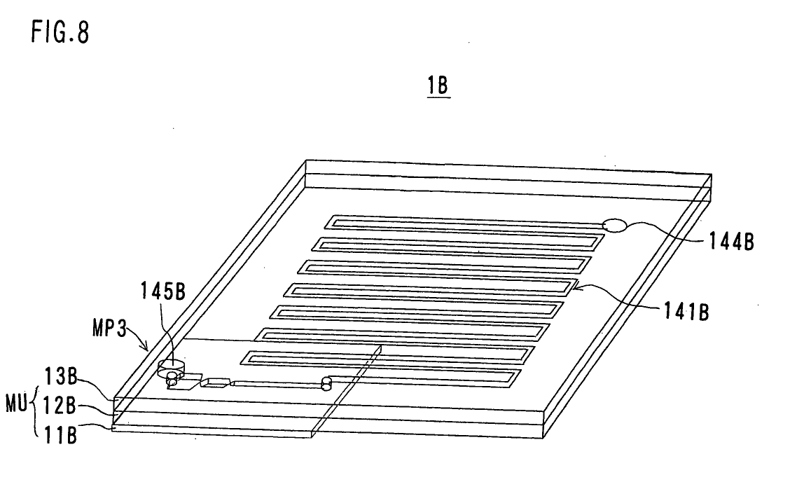

FIG. 8 is a perspective view of a microfluidic device 1B in which a micropump chip 11B having one micropump MP3 is used and a glass substrate 12B and a channel chip 13B are combined with the micropump chip 11B.

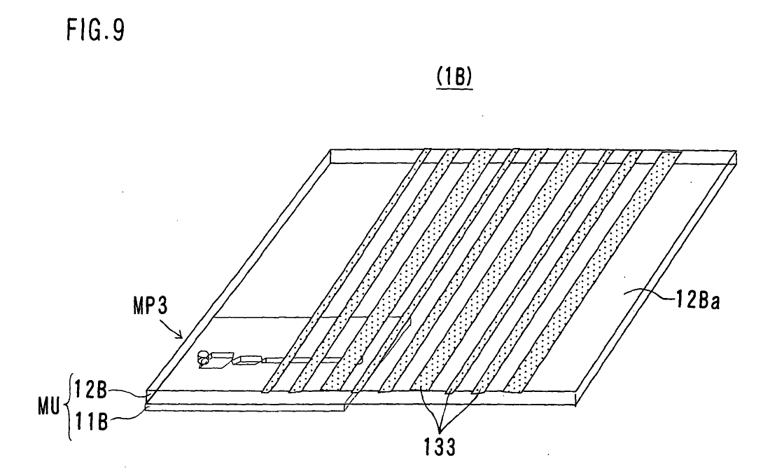

FIG. 9 is a perspective view showing a state in which the channel chip 13B of the microfluidic device 1B is removed.

Referring to FIG. 8, a channel 141B on the channel chip 13B is so structured that the channel meanders multiple times and the entire length thereof is long. Since the channel is long, it takes a couple of minutes through several tens of minutes until a liquid injected from a hole 145B reaches the hole 144B for discharge.

As shown in FIG. 9, ITO films 133 having various widths are patterned on a surface 12Ba of the glass substrate 12B. The upper surfaces of the ITO films 133 are coated with the PDMS as protection layers. The ITO films 133 are supplied with electric currents and generate heat depending on the width dimensions of the ITO film. For example, when each of the ITO films 133 is supplied with an electric current having the same magnitude, heating value depending on the width dimensions can be obtained. For example, the channel 141B can be heated to 92° C., 74° C., 53° C. and the like by each of the ITO films 133. Under such a state, when a sample liquid is flowed into the channel 141B, the sample liquid reaches the hole 144B for discharge with heat cycle being repeated. On this occasion, when DNA is added to the sample liquid for liquid transport, PCR (Polymerase Chain Reaction) occurs and the liquid in which DNA is amplified can be retrieved from the hole 144B.

According to the microfluidic device 1 mentioned above, one micropump chip 11 is bonded to one glass substrate 12. However, two or more micrompump chips 11 may be bonded thereto.

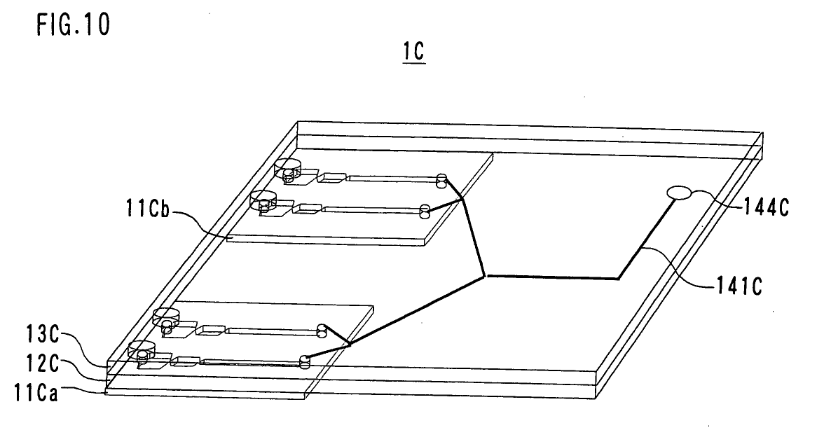

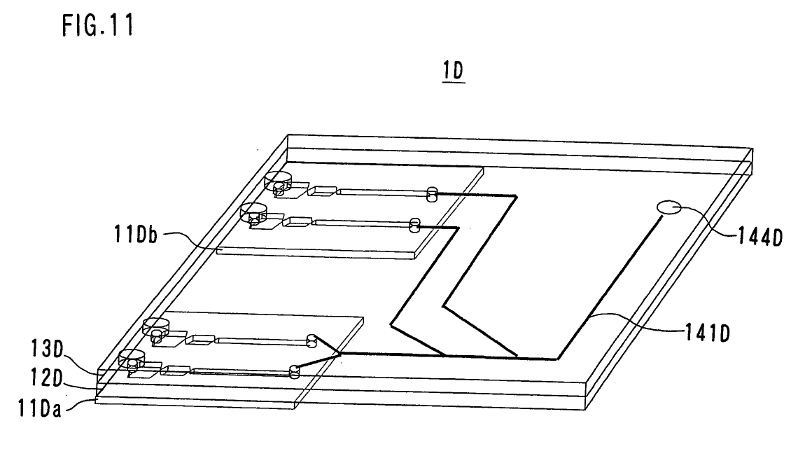

FIG. 10 shows a microfluidic device 1C structured by bonding two micropump chips 11Ca and 11Cb to one glass substrate 12C. Likewise, FIG. 11 shows a microfluidic device 1D structured by bonding two micropump chips 11Da and 11Db to one glass substrate 12D.

The microfluidic devices 1C and 1D can perform liquid transport for a variety of reaction sequences by various liquids.

As the form of the micropump MP, various forms other than the one mentioned above can be adopted. For example, it is possible to use a micropump in which an active member functioning as a valve is provided in lieu of each of the first throttle channel 123 and the second throttle channel 125 whose shape differs from that of the first throttle channel 123, and micropumps having other structures. [Second Embodiment]

Next, a microfluidic device according to a second embodiment is described.

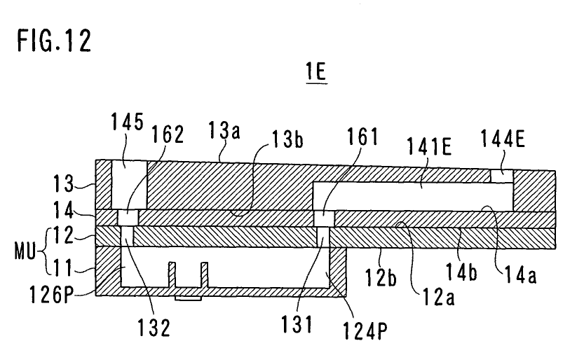

FIG. 12 is a front sectional view of a microfluidic device 1E according to the second embodiment.

In the first embodiment, the channel chip 13 having a self-sealing feature spontaneously adsorbs onto the micropump unit MU structured by the micropump chip 11 and the glass substrate 12. On the contrary, as shown in FIG. 12, the microfluidic device 1E according to the second embodiment is structured by sandwiching a sheet 14 having a self-sealing feature between a channel chip 13 and a micropump unit MU including a micropump chip 11 and a glass substrate 12. The sheet 14 is made from a PDMS, for example. The sheet 14 is provided with connection holes 161 for connecting through-holes 131 formed on the glass substrate 12 and hollows 142 and 143 formed on the channel chip 13 respectively, and connection holes 162 for connecting through-holes 132 and holes 145 and 146.

The sheet 14 has smooth surfaces 14a and 14b and is entirely transparent or translucent and has translucency. The upper surface 14a is bonded to a surface 13b of the channel chip 13, while the lower surface 14b is bonded to a surface 12a of the glass substrate 12. Each of the connection holes 161 and 162 opens to the surfaces 14a and 14b.

According to the microfluidic device 1E as structured above, the self-sealing feature of the sheet 14 facilitates the bonding between the sheet 14 and the glass substrate 12, and functions to bond the channel chip 13 to the sheet 14 readily even if the channel chip 13 has no self-sealing feature. More particularly, as a material for the channel chip 13, a hard material can be used such as a PMMA, a PC, a POM, other plastics, a glass, a silicon, ceramics, a polymer or others. Various molding enables large-scale production. Further, the surface 13b of the channel chip 13 is required to be smooth in order to be bondable to the surface 14a of the sheet 14. [Modified Example in the Second Embodiment]

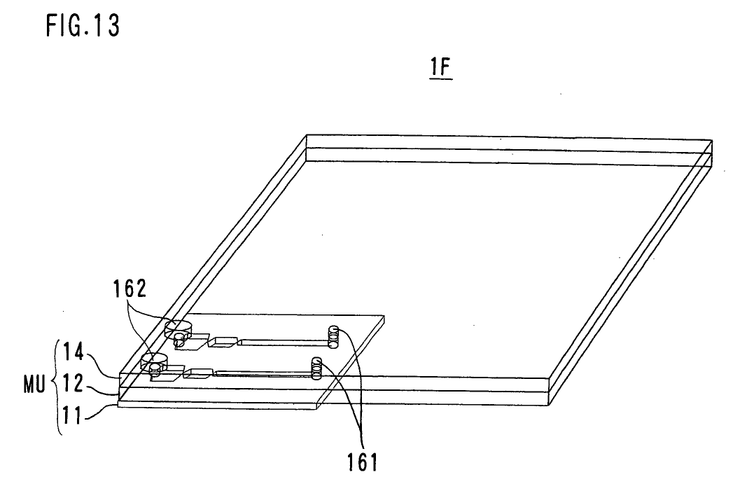

FIG. 13 is a perspective view of a modified microfluidic device 1F.

The microfluidic device 1F includes a micropump chip 11, a glass substrate 12 and a sheet 14 having a self-sealing feature. Stated differently, the microfluidic device 1F is the same as the microfluidic device 1E from which the channel chip 13 is removed.

This microfluidic device 1F has no channel chip 13, and therefore, is incomplete as a microfluidic device. However, the microfluidic device 1F functions as a micropump unit that can complete a microfluidic device by attaching the channel chip 13. In other words, according to the microfluidic device 1F, the channel chip 13 having an ambient channel 141 can be attached easily and thereby a microfluidic device capable of having various channels can be structured readily.

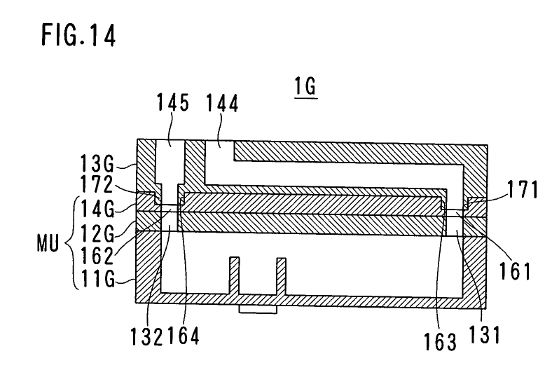

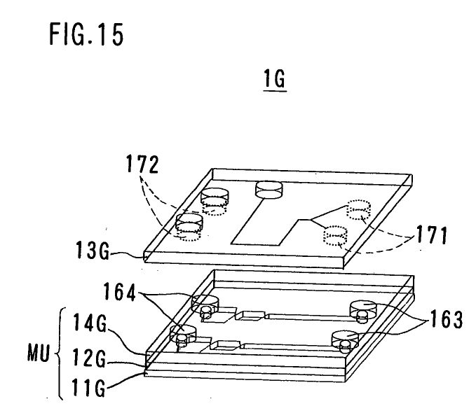

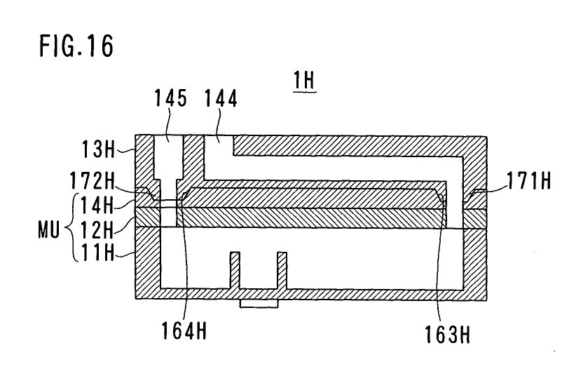

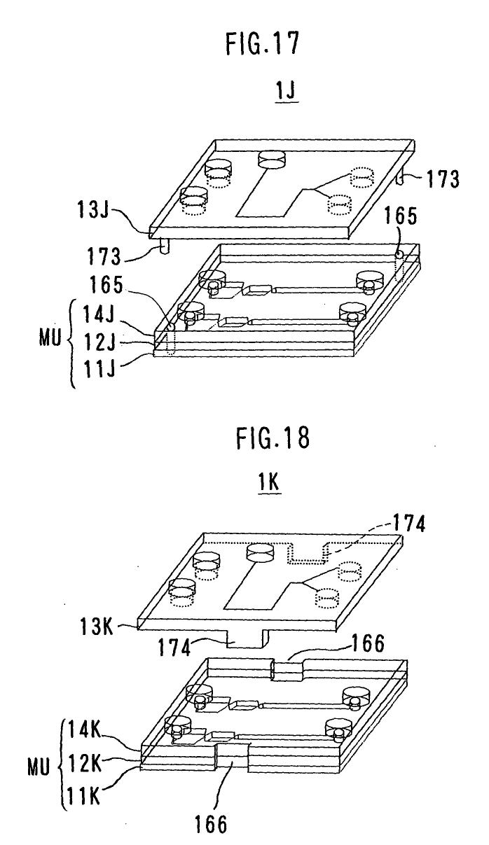

FIG. 14 is a front sectional view of another modified microfluidic device 1G, FIG. 15 is a perspective view of the microfluidic device 1G shown in FIG. 14, FIG. 16 is a front sectional view of still another modified microfluidic device 1H and FIGS. 17 and 18 are perspective views of further modified microfluidic devices 1J and 1K.

The microfluidic device 1G shown in FIGS. 14 and 15 has a glass substrate that is not as large as that of each of the microfluidic devices 1-1F discussed above. The glass substrate 12G, a sheet 14G and a channel chip 13G of the microfluidic device 1G are as large as a micropump chip 11G. In other words, each of the glass substrate 12G, the sheet 14G, the channel chip 13G and the micropump chip 11G has the same dimensions and the surface area of the microfluidic device 1G is small. Thus, the whole of the microfluidic device 1G is still smaller than each of the microfluidic devices 1-1F. The same is true of the microfluidic devices 1H-1K.

In the microfluidic device 1G, positioning can be performed easily and certainly when the channel chip 13G is fixed to a micropump unit MU including the micropump chip 11G, the glass substrate 12G and the sheet 14G.

More specifically, the sheet 14G is provided with cylindrical counterbores 163 and 164 at positions concentric with the positions where the connection holes 161 and 162 are formed. The channel chip 13G is provided with bosses 171 and 172 fitting into the counterbores 163 and 164.

Accordingly, when the channel chip 13G is fixed to the micropump unit MU, the bosses 171 and 172 on the channel chip 13G are fitted into the counterbores 163 and 164 on the sheet 14G, which allows the sheet 14 to adsorb spontaneously due to the self-sealing feature thereof. This further facilitates and ensures fixing of the channel chip 13 and ensures the positioning, leading to more stable operation of the microfluidic device 1G. Additionally, since no position deviation occurs during carrying, the microfluidic device 1G can be carried and handled easily.

According to the microfluidic device 1H shown in FIG. 16, counterbores 163H and 164H and bosses 171H and 172H are truncated cone-like. In the illustrated example, each of the counterbores 163H and 164H extends in a tapered shape, which further facilitates insertion.

In the microfluidic device 1J shown in FIG. 17, a micropump unit MU is provided with elongated cylindrical hollows 165 for positioning, the micropump unit MU including a micropump chip 11J, a glass substrate 12J and a sheet 14J. A channel chip 13J is provided with pins 173 for fitting into the hollows 165. The pins 173 are inserted into the hollows 165 respectively, and thereby, positioning of the micropump unit MU and the channel chip 13J is performed.

In the microfluidic device 1K shown in FIG. 18, a micropump unit MU is provided with rectangular parallelepiped-like notches 166 for positioning at the side surfaces thereof, the micropump unit MU including a micropump chip 11K, a glass substrate 12K and a sheet 14K. A channel chip 13K is provided with projections 174 for fitting into the notches 166. The projections 174 are fitted into the notches 166 respectively, and thereby, positioning is performed.

Thus, it is possible to carry out positioning of the micropump unit MU and the channel chip 13J or 13K by adopting the structure of the microfluidic device 1J or 1K.

The microfluidic devices 1J and 1K shown in FIGS. 17 and 18 do not necessarily include the bosses 171 and 172 and the counterbores 163 and 164 that are described with reference to the microfluidic device 1G shown in FIG. 15.

In the embodiments discussed above, the microfluidic devices 1-1K or the micropump unit MU correspond to a microfluidic device according to the present invention. The micropump unit MU also corresponds to a pump unit of the present invention. In the micropump unit MU, for example, the surface 12a of the glass substrate 12, the micropump chip 11 or the micropump MP, and the through-holes 131 and 132 correspond to a first joint surface, a pumping mechanism, and a channel or a first channel of the present invention, respectively.

The channel chip 13, 13B or the like is equivalent to a channel unit of the present invention. In the channel chip 13, for example, the surface 13b corresponds to a second joint surface, and the hollows 142 and 143 and the holes 144-146 correspond to a channel or a second channel of the present invention, respectively.

The sheet 14G, 14J or the like is equivalent to a sheet member of the present invention. For instance, one surface 14a of the sheet 14G or 14J, the other surface 14b thereof, and the connection holes 161 and 162 correspond to a fourth joint surface, a third joint surface and connection holes of the present invention, respectively.

In the various embodiments and the modified examples discussed above, the planar shapes of the microfluidic devices can be square, rectangle, polygon, circle, oval or various other shapes. A variety of things can be used for a structure, a configuration and a material of the channel chip, a configuration, a pattern and a length of the channel, a cross-sectional shape and cross-sectional dimensions of the channel, and others. A configuration, a structure, a principle, a form, a shape, dimensions and a driving method of the micropump MP of the micropump chip can be various things other than those above. Structures, shapes, dimensions, numbers and materials of each part or whole part of the microfluidic device can be varied within the scope of the present invention.

The microfluidic device of the present invention can apply to reactions in various fields including environment, food product, biochemistry, immunology, hematology, a genetic analysis, a synthesis and drug development.

What is claimed is:

1. A microfluidic device comprising:
a pump unit including a first joint surface, a pumping mechanism and a channel that connects to the pumping mechanism and opens to the first joint surface; and
a channel unit including a second joint surface for being detachably joined to the first joint surface and a channel that opens to the second joint surface and is connectable to the channel of the pump unit,
wherein at least one of a material constituting the first joint surface and a material constituting the second joint surface is an elastic material having a self-sealing feature.

2. The microfluidic device according to claim 1, wherein the elastic material having a self-sealing feature is a PDMS.

3. The microfluidic device according to claim 1, wherein the elastic material having a self-sealing feature has translucency.

4. The microfluidic device according to claim 1, further comprising a member for positioning between the pump unit and the channel unit.

5. The microfluidic device according to claim 1, wherein the pump unit is structured by a pump portion including the pumping mechanism, and a sheet-like member that connects to the pumping mechanism and opens to the first joint surface.

6. A microfluidic device comprising:
a pump unit including a first joint surface, a pumping mechanism and a first channel that connects to the pumping mechanism and opens to the first joint surface;
a channel unit including a second joint surface and a second channel opening to the second joint surface; and
a sheet-like member including a third joint surface to be bonded to the first joint surface, a fourth joint surface to be bonded to the second joint surface and a connection hole for connecting the first channel and the second channel,
wherein the sheet-like member is made from an elastic material having a self-sealing feature and is detachably joined to at least one of the channel unit and the pump unit.

7. The microfluidic device according to claim 6, wherein the elastic material having a self-sealing feature is a PDMS.

8. The microfluidic device according to claim 6, wherein the elastic material having a self-sealing feature has translucency.

9. The microfluidic device according to claim 6, further comprising a member for positioning between the pump unit and the channel unit.

10. A pump unit used for a microfluidic device including the pump unit and a channel unit that has a joint surface and a channel opening to the joint surface, the pump unit comprising:
a first joint surface for being detachably joined to the joint surface of the channel unit;
a pumping mechanism; and
a channel that connects to the pumping mechanism, opens to the first joint surface and is connectable to the channel of the channel unit,
wherein a material constituting the first joint surface is an elastic material having a self-sealing feature.

11. The pump unit according to claim 10, wherein the elastic material having a self-sealing feature is a PDMS.

12. The pump unit according to claim 10, wherein the elastic material having a self-sealing feature has translucency.

13. The pump unit according to claim 10, further comprising a member for positioning between the pump unit and the channel unit.

14. The pump unit according to claim 10, further comprising a pump portion including the pumping mechanism, and a sheet-like member including a channel that connects to the pumping mechanism and opens to the first joint surface.

15. A channel unit used for a microfluidic device including the channel unit and a pump unit that has a pumping mechanism, a joint surface and a channel opening to the joint surface, the channel unit comprising:
a second joint surface for being detachably joined to the joint surface of the pump unit: and
a channel that opens to the second joint surface and is connectable to the channel of the pump unit,
wherein a material constituting the second joint surface is an elastic material having a self-sealing feature.

16. The channel unit according to claim 15, wherein the elastic material having a self-sealing feature is a PDMS.

17. The channel unit according to claim 15, wherein the elastic material having a self-sealing feature has translucency.

18. The channel unit according to claim 15, further comprising a member for positioning between the pump unit and the channel unit.
